(19) United States
(12) Patent Application Publication
(10) Pub. No.: US 2012/0072304 A1
(43) Pub. Date: Mar. 22, 2012

(54) Method of Shopping Online with Real-Time Data Sharing Between Multiple Clients

(76) Inventor: Sven HOMAN, Redondo Beach, CA (US)

(21) Appl. No.: 13/235,340

(22) Filed: Sep. 16, 2011

Related U.S. Application Data
(60) Provisional application No. 61/383,830, filed on Sep. 17, 2010.

(51) Int. Cl. G06Q 30/00

(52) U.S. Cl. 705/26.8

(57) ABSTRACT

The present invention is a web-based software that allows users to shop online together by allowing multiple shoppers to attend a common shopping session in real-time. The present invention is designed to be used as a mobile phone application but can also be used through other internet interfaces such as a dynamic website or a desktop application. The shopping session allows the multiple shoppers to communicate about different online merchandise through a voice channel, and the common share list for the shopping session allows each shopper to post an appealing product for the other shoppers to view. The features of the web-based software provide each shopper with a display to keep track of who else in the shopping session. The features also provide each shopper with the ability to transfer online products to the other shoppers' shopping carts.

The current application claims a priority to the U.S. Provisional Patent application Ser. No. 61/383,830 filed on Sep. 17, 2010.

### FIELD OF THE INVENTION

The present invention relates generally to a mobile phone application that allows users to shop together and share information about different online merchandise in real-time.

### BACKGROUND OF THE INVENTION

The present invention is a web-based software that allows users to shop online together. In the preferred embodiment, the web-based software is used as a mobile phone application and is designed to function with a touch screen. Though, the present invention can also be accessed as a dynamic website, a desktop application, or any other internet connected software. The web-based software allows a shopper to create a shopping session, invite other shoppers to a shopping session, or join an active shopping session. Once the shopper has joined a shopping session, the present invention allows the shopper to see what merchandise the other shoppers in the shopping session are viewing and allows the shopper to communicate with the other shoppers via a voice channel. The present invention also allows the shoppers within the shopping session to transfer online merchandise between their shopping carts. In addition, the web-based software allows the shopper to follow and see what online merchandise the other shoppers are viewing. The web-based software provides the shopper with the option to shop alone, but the collaborative functions between shoppers makes the present invention unique.

### BRIEF DESCRIPTION OF THE DRAWINGS

FIG. 1 illustrates the client-server architecture of the present invention, where the SIP server is only included in certain embodiments of the present invention.

FIG. 2 is a simplified flow chart of the overall process of the present invention from the perspective of the first temporary account.

FIG. 3 highlights the process of using the product search feature to find a particular product from the perspective of the first temporary account.

FIG. 4 highlights the process of using the main menu feature to find a particular product from the perspective of the first temporary account.

FIG. 5 highlights the process of using the session participant feature to find a particular product from the perspective of the first temporary account.

FIG. 6 highlights the process of using the shopper following mode from the perspective of the first temporary account.

FIG. 7 highlights the process of transferring a particular product between shopping carts from the perspective of the first temporary account.

FIG. 8 depicts the options provided by the home screen.

FIG. 9 depicts the constant arrangement of the main menu feature, the session participant feature, and the product search feature.

FIG. 10 depicts the options provided by the product detail screen of a particular product.

FIG. 11 depicts how the preferred embodiment of the present invention prompts the first temporary account to enter shopper following mode with the second temporary account, while the first temporary account is viewing the same product detail screen as the second temporary account through the session participant feature.

FIG. 12 depicts how the preferred embodiment of the present invention prompts the first temporary account to exit shopper following mode with the second temporary account, while the first temporary account is viewing the same product detail screen as the second temporary account through the session participant feature.

FIG. 13 depicts how the preferred embodiment of the present invention prompts the first temporary account to transfer items between the shopping carts of the other temporary accounts in the shopping session.

FIG. 14 depicts how the preferred embodiment of the present invention prompts the first temporary account to compile the list of transfer items.

FIG. 15 depicts how the preferred embodiment of the present invention prompts the first temporary account to choose which products on the list of transfer items to transfer back to the shopping cart of the first temporary account.

FIG. 16 depicts how the preferred embodiment of the present invention prompts the second temporary account to accept or decline the transfer of products from the shopping cart of the first temporary account to the shopping cart of the second temporary account.

### DETAIL DESCRIPTIONS OF THE INVENTION

All illustrations of the drawings are for the purpose of describing selected versions of the present invention and are not intended to limit the scope of the present invention.

The present invention is an ecommerce web-based software platform, which allows multiple users to shop together by exchanging information about different products in real-time. The present invention performs its functions with a central server. A shopper can access the central server with a temporary account. Because the present invention is designed to accommodate for multiple users, the present invention allows for the plurality of shoppers to access the central server with a plurality of temporary accounts. The central server also manages a plurality of shopping sessions, which groups the plurality of temporary accounts and allows different users to shop together. Each of the plurality of temporary accounts has the ability to create a new shopping session, to invite other temporary accounts to an active shopping session, to join an active shopping session, or to leave an active shopping session. These and other functions of the present invention are activated through the home screen, the product detail screen, the main menu feature, the session participant feature, and the product search feature. The primary function of the present invention is to search through a list of products in order to find a particular product, which a user would like to purchase. The description data associated with the particular product can then be shared with the other temporary accounts in the active shopping session.

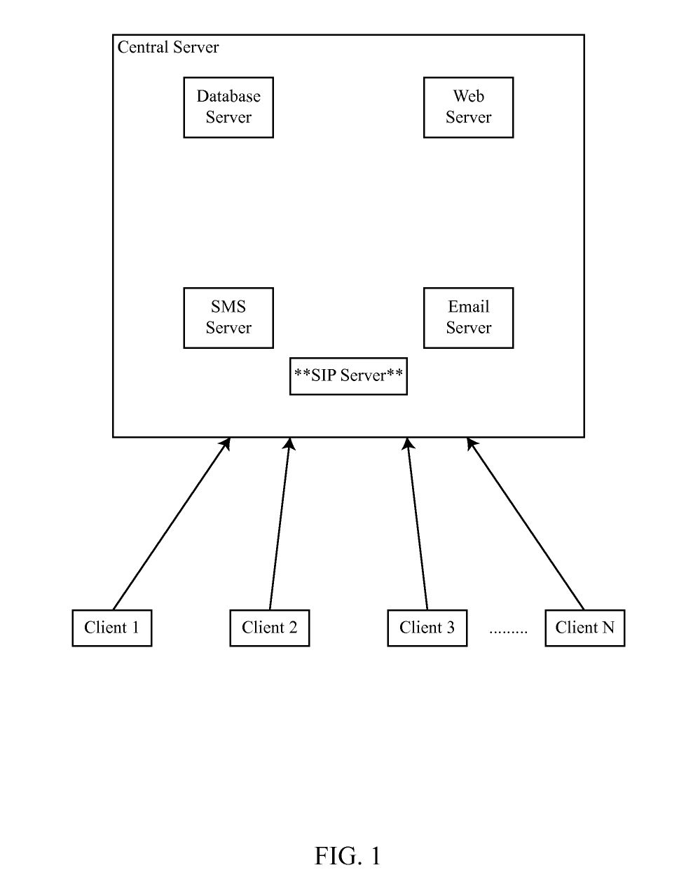

As can be seen in FIG. 1, the present invention uses a client-server architecture between the plurality of temporary accounts and the central server in order to perform the functions of the present invention. The central server comprises a database server, a web server, an SMS server, and an email server. The central server utilizes the database server to store and access data that allows the present invention to properly execute its functions. The web server provides the plurality of temporary accounts a means to interact with each other and the present invention. The SMS server allows the plurality of temporary accounts to communicate with each other via text messaging, and the email server allows the plurality of temporary accounts to communicate to each other via email. The central server utilizes the pull method to manage the plurality of shopping sessions. The pull method updates the temporary accounts within a shopping session at regular intervals with the database server and the web server. In another embodiment of the present invention, the SIP server is used to manage the plurality of shopping sessions. The implementation of the SIP server into the central server is more complex than using the pull method, but the SIP server is more efficient with bandwidth.

The plurality of temporary accounts allows the plurality of shoppers to access the central server and, thus, use the present invention. Each of the plurality of temporary accounts are independent of a shopping session and is able to transfer data associated with that temporary account from one shopping session to another. Each of the plurality of temporary accounts comprises a screen name, a contact data, a shopping cart, and a wish list. The screen name allows the present invention to distinguish each of the plurality of temporary accounts from each other. The contact data is information that can be used to communicate with a shopper such as a telephone number and an email address. The shopping cart is used to store a particular product from the list of products, until the shopper is done browsing through the list of products and is ready to electronically purchase the particular product. The wish list is used to store a particular product from the list of products, until the shopper has the financial funds to electronically purchase the particular product.

The present invention allows the temporary accounts within each of the plurality of shopping sessions to communicate with each other and shop together. Each of the plurality of shopping sessions comprises a list of participants, a session identification, a session link, a share list, and a voice channel. The list of participants allows the present invention to keep track of which of the plurality of temporary accounts is included in which of the plurality of shopping sessions. The session identification is a string of characters, which is used to differentiate each of the plurality of shopping sessions from one another. The session link of each of the plurality of shopping sessions is web address that allows the plurality of temporary accounts to find a particular shopping session. The share list allows each of the plurality of temporary accounts on the list of participants to store and share a particular product with the other temporary accounts on the list of participants. The voice channel allows each of the plurality of temporary accounts on the list of participants to vocally communicate with each other. In addition, each of the plurality of shopping sessions can either be a new shopping session or an active shopping session. A new shopping session has yet to include any temporary accounts on its list of participants, and an active shopping session does include temporary accounts on its list of participants. A new shopping session becomes an active shopping session when the list of participants includes at least one temporary account.

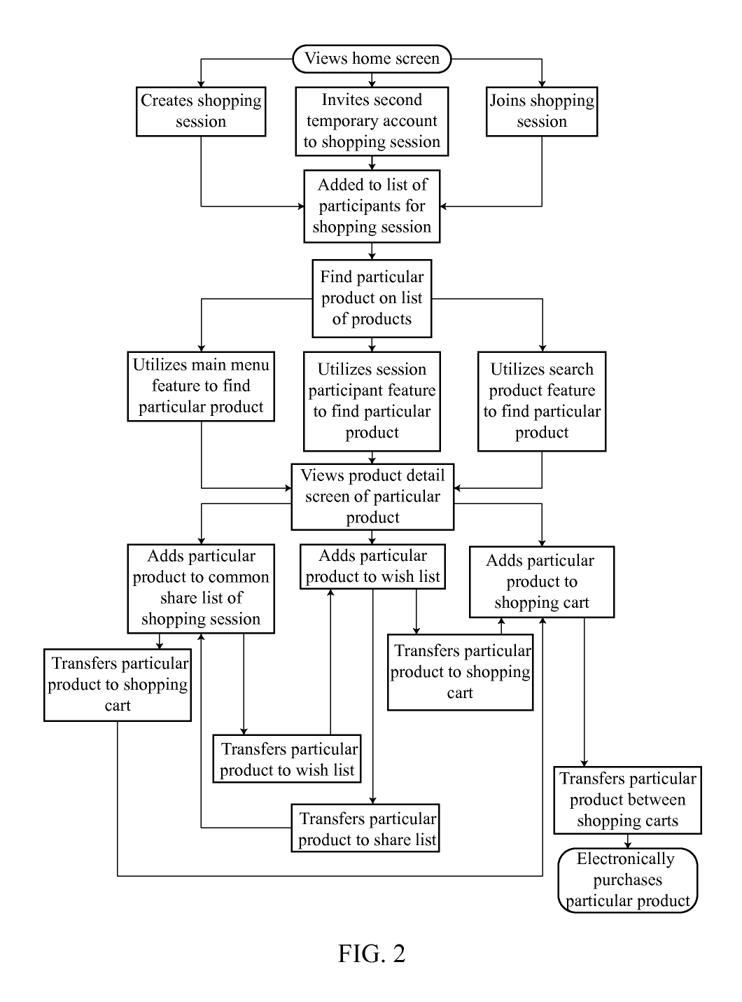

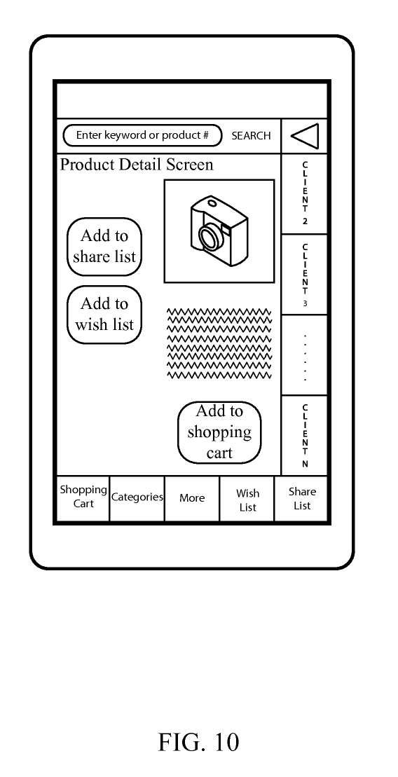

Users of the present invention follow a process shown in FIG. 2 that allows them to shop together by exchanging information about different products in real-time. The process uses different graphical interfaces to activate functions on the present invention. Those graphical interfaces include a home screen, a main menu feature, a session participant feature, a product search feature, and a product detail screen. The present invention begins by providing the shoppers with access to the central server through the plurality of temporary accounts. The plurality of temporary accounts comprises a first temporary account and a second temporary account. The first temporary account can be used to typify any of the plurality of temporary accounts. In addition, the first temporary account and the second temporary account can be used to typify the interaction and functional relationship between any two temporary accounts. Once the first temporary account is used to access the central server, the present invention displays the home screen, which can be seen in FIG. 10, to the first temporary account. The present invention prompts the first temporary account with the home screen to choose between starting a new shopping session, inviting the second temporary account to join an active shopping session, or joining an active shopping session. If the shopper chooses to create a new shopping session, then the present invention creates the new shopping session as a state within the database server and the computer core of the central server or with the optional SIP server. The present invention also generates a session identification and a session link for the new shopping session. Once the new shopping session is created and maintained by the central server, the present invention adds the first temporary account to the list of participants, which changes the new shopping session into an active shopping session. If the shopper chooses to invite other temporary accounts to the join an active shopping session, then the present invention retrieves the contact data of the second temporary account from the first temporary account and sends a session invitation with the SMS server and the email server. The session invitation includes the session identification and the session link of the active shopping session, which are used by the second temporary account to access the active shopping session. If the shopper chooses to join an active shopping session, then the present invention will retrieve the session identification or the session link to find the active shopping session among the plurality of shopping sessions that the first temporary account is trying to join. Once the present invention finds the active shopping session with either the session identification or the session link, the present invention will add the first temporary account to the list of participants of the active shopping session.

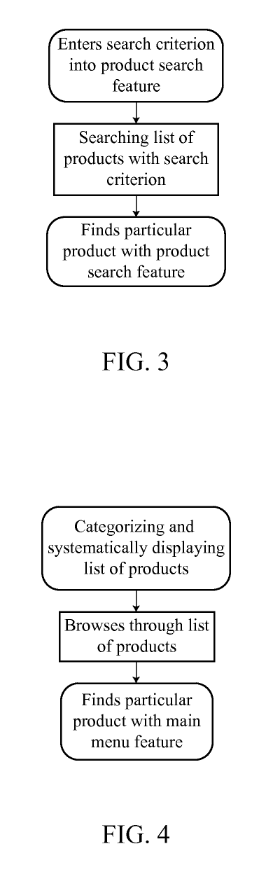

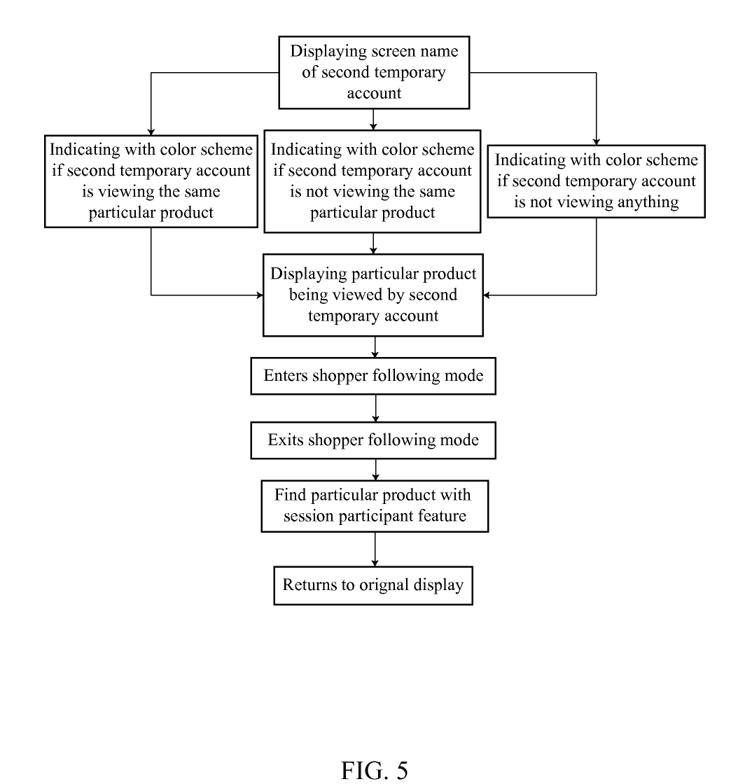

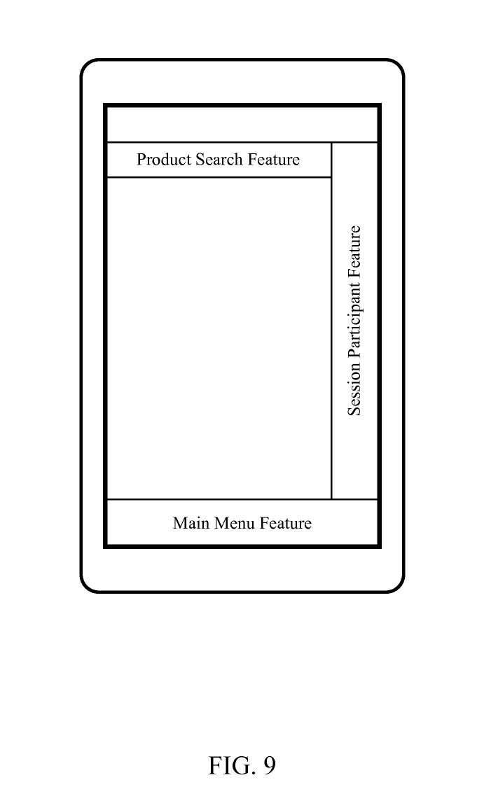

After the first temporary account is added to the list of participants, the present invention will permanently display the main menu feature, the session participant feature, and the product search feature, until the first temporary account leaves the active shopping session. The main menu feature, the session participant feature, and the product search feature is shown in FIG. 9. The primary objective of the present invention is to find a particular product that the shopper wants to purchase, which can be done with the main menu feature, the session participant feature, or the search product feature as can be seen in FIGS. 3, 4, and 5. The main menu feature finds a particular product by categorizing and systematically displaying the list of products to the first temporary account, which will allow the shopper to easily browse through the list of products with the present invention. Once the shopper finds the particular product with the main menu feature, the present invention will display the product detail screen for the particular product. The product search feature finds a particular product by prompting the first temporary account to enter a product search criterion. The product search criterion allows the present invention to search through the list of products and find the particular product. In the preferred embodiment of the present invention, the product search criterion is either a keyword or a product number that differentiate the particular product on the list of products. Once the shopper finds the particular product on the list of the products with the product search feature, the present invention will display the product detail screen for the particular product.

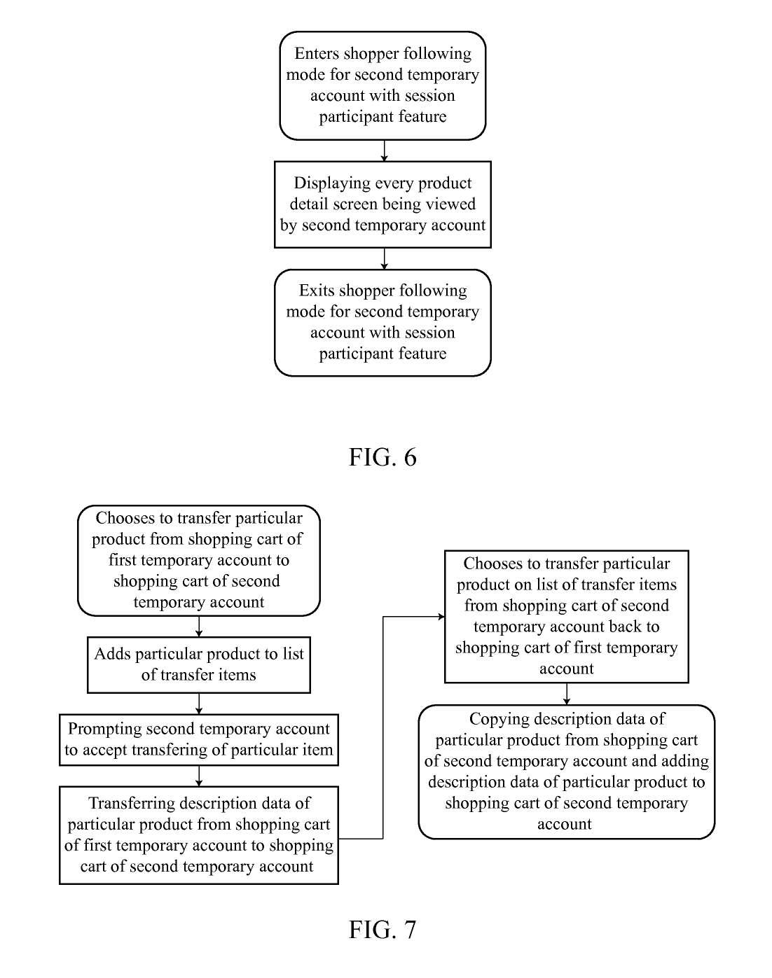

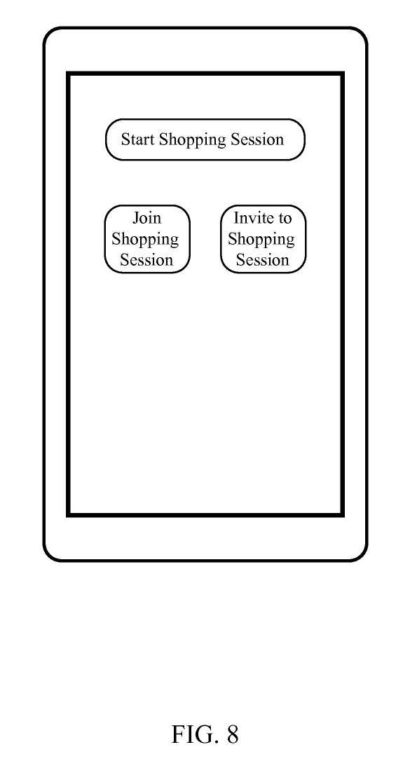

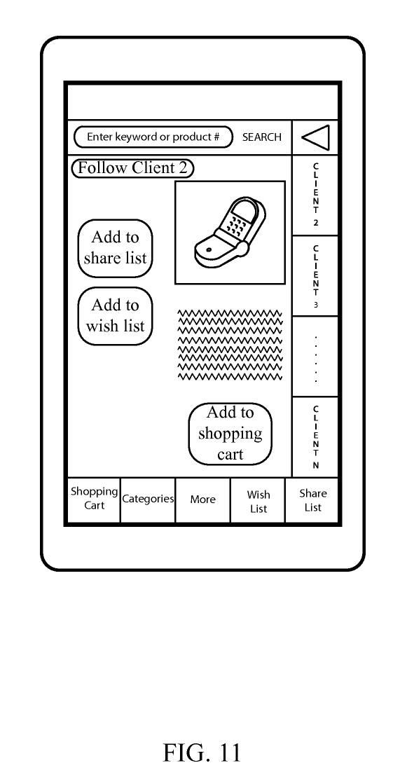

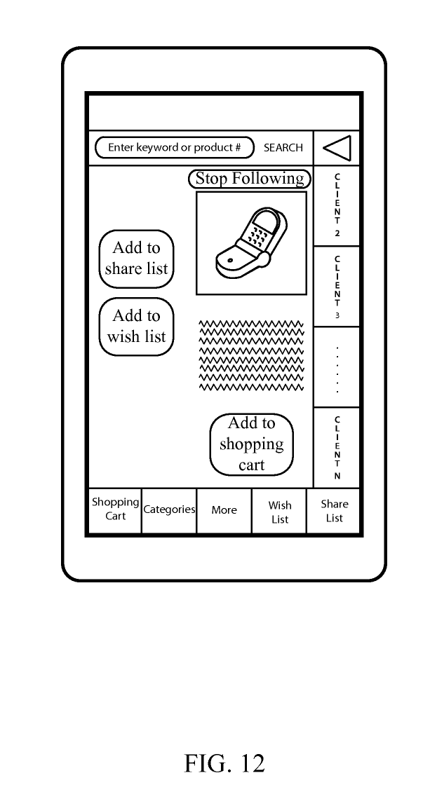

The session participant feature allows a shopper to see which products that the other shoppers in the active shopping session are viewing, which also allows the shopper to find a particular product via the other shoppers. The session participant feature also allows the first temporary account to see which other temporary accounts are in the active shopping session. If a second temporary account is added to the list of participants with the first temporary account, then the session participant feature displays the screen name of the second temporary account to the first temporary account. The session participant feature uses a color scheme to highlight the screen name of the second temporary account in order to indicate to the first temporary account what second temporary account is viewing. If the second temporary account is viewing the same particular product as the first temporary account, then the session participant feature will highlight the screen name of the second temporary account with one color from the color scheme. If the second temporary account is not viewing the same particular product as the first temporary account, then the session participant feature will highlight the screen name of the second temporary account with a different color from the color scheme. If the second temporary account is not viewing a particular product, then the session participant feature will highlight the screen of the second temporary account with another color from the color scheme. In the preferred embodiment of the present invention, the session participant feature highlights the screen name in green if the second temporary account is viewing the same particular product, in red if the second temporary account is not viewing the same particular product, and in grey if the second temporary account is not viewing a particular product. The session participant feature prompts the first temporary account to view the same particular product as the second temporary account on the product detail screen. Once the present invention displays the product detail screen of the same particular product to the first temporary account, the session participant feature prompts the first temporary account either to return to the product detail screen previously viewed by the first temporary account or to enter a shopper following mode, which is illustrate in FIG. 6. If the first temporary account enters the shopper following mode, then the present invention will display every product detail screen that is viewed by the second temporary account to the first temporary account. The session participant feature prompts the first temporary account to exit the shopper following mode, while the first temporary account is in the shopper following mode. In the preferred embodiment, the present invention would prompt the first temporary account with an icon on the product detail screen to start the shopper following mode with the second temporary account, which is shown in FIG. 11, and would prompt the first temporary account with another icon on the product detail screen to exit the shopper following mode, which is shown in FIG. 12.

The present invention allows the first temporary account to access any product detail screen viewed through either the main menu feature, the session participant feature, or the product search feature. The product detail screen displays the description data for a particular product to the first temporary account and is illustrated in FIG. 10. The description data of a particular product includes information about the particular product such as the price, the summary, the rating, and the reviews. Once the first temporary account is viewing the product detail screen of a particular product, then the present invention will prompt the first temporary account either to add the particular product to the shopping cart of the first temporary account, to add the particular product to the wish list of the first temporary account, or to add the particular product to the share list of the active shopping session. If the first temporary account chooses to add the particular product to their shopping cart, then the present invention will copy and transfer the description data of the particular product to the shopping cart of the first temporary account. If the first temporary account chooses to add the particular product to their wish list, then the present invention will copy and transfer the description data of the particular product to the wish list of the first temporary account. If the first temporary account chooses to add the particular product to the share list, then the present invention will copy and transfer the description data of the particular product to the share list of the active shopping session.

The main menu feature also provides the first temporary account with the same options as the home screen, which include creating a new shopping session, inviting a second temporary account to an active shopping session, and joining a different active shopping session, except the main menu feature also prompts the first temporary account to leave the active shopping session. If the shopper chooses to leave the active shopping session, then the present invention will remove the first temporary account from the list of participants of the active shopping session. Once the first temporary account leaves the active shopping session, the present invention keeps the screen name, the contact data, the shopping cart, and the wish list of the first temporary account in tact because that data is associated with the first temporary account and not the active shopping session.

Other options provided by the main menu feature to the first temporary account include viewing the contents of the shopping cart of the first temporary account, viewing the contents of the wish list of the first temporary account, viewing the contents of the share list of the active shopping session, and transferring a particular product between the shopping cart of the first temporary account and the shopping cart of the second temporary account. When the first temporary account chooses to view the share list of the active shopping session with the main menu feature, then the present invention will display the description data of the particular product added to the share list and will prompt the first temporary account to add the particular product to either the wish list or the shopping cart of the first temporary account. The present invention can copy and transfer the description data of the particular product from the share list to either the wish list or the shopping cart of the first temporary account if the first temporary account chooses to do so. The present invention also displays who from the list of participants contributed what product to the share list at what time. When the first temporary account chooses to view its wish list with the main menu feature, then the present invention will display the description data of the particular product added to the wish list and will prompt the first temporary account to add the particular product to the shopping cart of the first temporary account. The present invention can copy and transfer the description data of the particular product from the wish list to either the share list or the shopping cart of the first temporary account. When the first temporary account chooses to view its shopping cart, the present invention will display the description data of the particular product added to the shopping cart and will prompt the first temporary account to electronically purchase the particular product.

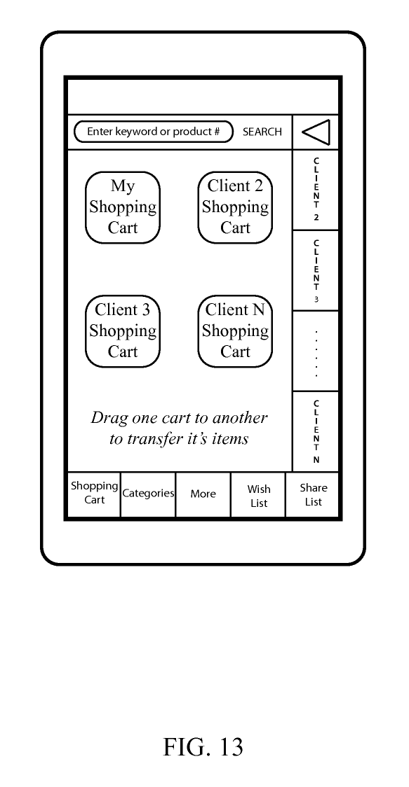

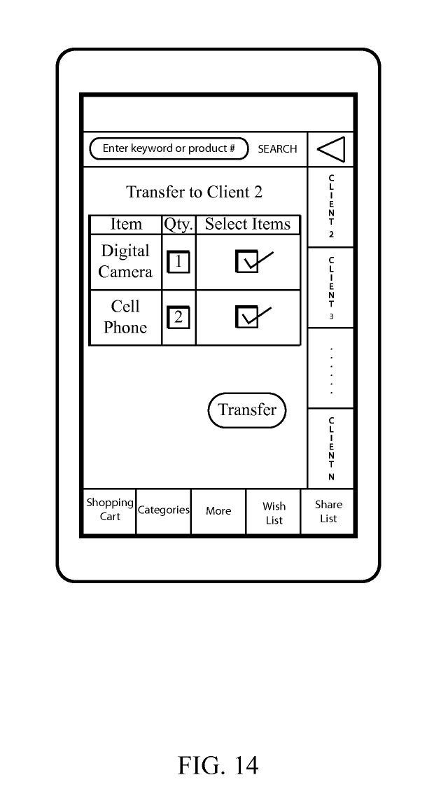

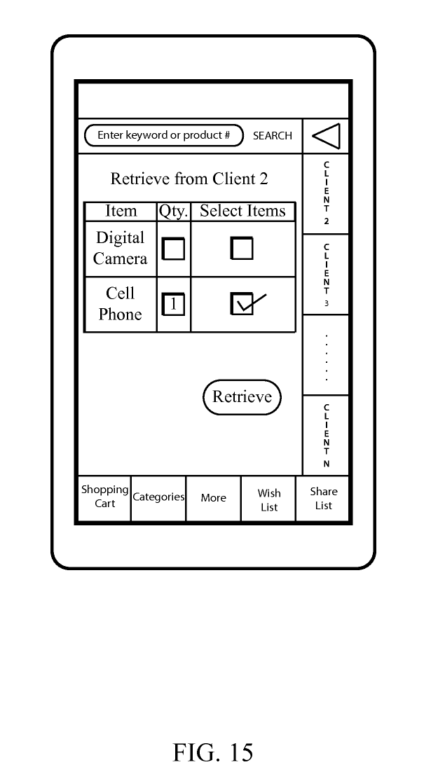

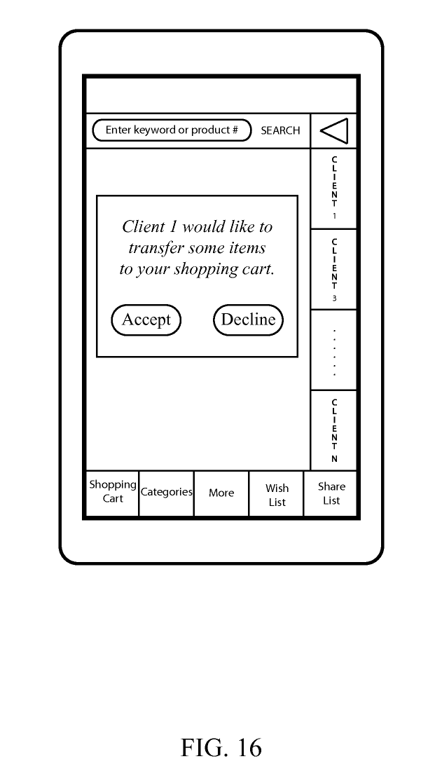

In order to transfer a particular product between the shopping cart of the first temporary account and the shopping cart of the second temporary account with the main menu feature, the present invention prompts the first temporary account to compile a list of transfer items from the shopping cart, which is displayed to the first temporary account on a screen shown in FIG. 14. The present invention allows the first temporary account to add the particular product to the list of transfer items and allows the first temporary account to only transfer the particular product on the list of transfer items between the shopping cart of the first temporary account and the shopping cart of the second temporary account. Once the list of transfer items is completed by the first temporary account, the present invention prompts the second temporary account to accept transfer of the particular product from the shopping cart of the first temporary account to the shopping cart of the second temporary account, which is displayed to the second temporary account on a screen shown in FIG. 16. If the second temporary account accepts the transfer of the particular product, then the present invention will transfer the description data of the particular product on the list of transfer items from the shopping cart of the first temporary account to the shopping cart of the second temporary account. The main menu feature allows the first temporary account to also transfer the particular product on the list of transfer items from the shopping cart of the second temporary account back to the shopping cart of the first temporary account, which is displayed on a screen shown in FIG. 15. The present invention does not allow the first temporary account to transfer a particular product that is not on the list of transfer items because the present invention needs to keep the shopping cart of the second temporary account private from the first temporary account. In the preferred embodiment of the present invention, the main menu feature prompts the first temporary account to transfer a particular product from one shopping cart to another with a graphical user interface, which uses shopping cart icons that are shown in FIG. 13 to represent each of the temporary accounts in the active shopping session. The shopper using the first temporary account initiates a transfer between two shopping carts by placing one shopping cart icon onto another shopping cart icon with the graphical user interface. Also in the preferred embodiment, before the description data of a particular product is transferred between shopping carts, the present invention prompts the first temporary account to specify the quantity of the particular product that should be added to the shopping cart. In another embodiment of the present invention, the first temporary account does not compile a list of transfer items and is able to transfer the entire content of a shopping cart to another shopping cart. The entire method of transferring products between the shopping cart of the first temporary account and the shopping cart of the second temporary account is shown in FIG. 7.

On a deeper technical level, the innovation behind the present invention is implementing the plurality of shopping sessions without using any SIP servers. The present invention provides real-time sharing of data via the pull method where each temporary account periodically pulls data from the database server for the updates to the shopping session's data. The database server acts as a hub for exchange of data between the temporary accounts that were temporarily joined in the same shopping session. Same sharing of data can however be also implemented using an additional intermediary SIP server, which enables the push method of data update from the central server to the temporary account. Implementation using a SIP server is more complex but is more bandwidth efficient because changes are only pushed to clients when changes occur rather than each temporary account having to check for changes in short intervals.

Although the invention has been explained in relation to its preferred embodiment, it is to be understood that many other possible modifications and variations can be made without departing from the spirit and scope of the invention as hereinafter claimed.

What is claimed is:

1. A method of shopping online with real-time data sharing between multiple clients by executing computer-executable instructions stored on a non-transitory computer-readable medium, the method comprises the steps of:
providing a plurality of temporary accounts, wherein each of said plurality of temporary accounts has a screen name, a contact data, a shopping cart, and a wish list;
providing a first temporary account and a second temporary account, wherein said plurality of temporary accounts comprises said first temporary account and said second temporary account;
providing a central server, wherein said central server comprises a database server, a web server, an SMS server, and an email server;
providing a list of products, wherein said list of products is stored on said database server;
permitting each of said plurality of temporary accounts to access said central server;
displaying a home screen with said web server to each of said plurality of temporary accounts;
creating a plurality of shopping sessions through said home screen, wherein each of said plurality of shopping sessions has a list of participants, a session identification, a session link, a share list, and a voice channel;
providing a new shopping session and an active shopping session, wherein said plurality of shopping sessions is either said new shopping session or said active shopping session;
managing said plurality of shopping sessions with a pull method with said web server and said database server;
dividing said plurality of temporary accounts among said plurality of shopping sessions;
displaying a main menu feature, a session participant feature, and a product search feature to each of said plurality of temporary accounts with said web server;
finding a particular product in said list of products for each of said plurality of temporary accounts, wherein said particular product has detailed description data;
sharing said detailed description data of said particular product with each of said plurality of temporary accounts on said list of participants by adding said particular product to said share list of said active shopping session;
purchasing said particular product for each of said plurality of temporary accounts; and
removing said plurality of temporary accounts from said list of participants of each of said plurality of shopping sessions.

2. The method of shopping online with real-time data sharing between multiple clients by executing computer-executable instructions stored on a non-transitory computer-readable medium, the method as claimed in claim 1 comprises,
prompting said first temporary account with said home screen to choose between starting said new shopping session, inviting said second temporary account to join said active shopping session, and joining said active shopping session; and
prompting said first temporary account with said main menu feature to choose between starting said new shopping session, inviting said second temporary account to join said active shopping session, joining said active shopping session, and leaving said active shopping session.

3. The method of shopping online with real-time data sharing between multiple clients by executing computer-executable instructions stored on a non-transitory computer-readable medium, the method as claimed in claim 2 comprises,
generating said new shopping session;
creating said session identification and said session link for said new shopping session;
retrieving said screen name of said first temporary account; and
changing said new shopping session into said active shopping session by adding said first temporary account to said list of participants of said new shopping session.

4. The method of shopping online with real-time data sharing between multiple clients by executing computer-executable instructions stored on a non-transitory computer-readable medium, the method as claimed in claim 2 comprises,
retrieving said contact data for said second temporary account; and
sending a session invitation with said SMS server and said email server, wherein said session invitation includes said session identification and said session link for said active shopping session.

5. The method of shopping online with real-time data sharing between multiple clients by executing computer-executable instructions stored on a non-transitory computer-readable medium, the method as claimed in claim 2 comprises,
retrieving said session identification from said first temporary account to find said active shopping session or retrieving said session link from said first temporary account to follow to said active shopping session;
retrieving said screen name of said first temporary account; and
adding said first temporary account to said list of participants of said active shopping session.

6. The method of shopping online with real-time data sharing between multiple clients by executing computer-executable instructions stored on a non-transitory computer-readable medium, the method as claimed in claim 2 comprises,
removing said first temporary account from said list of participants of said active shopping session.

7. The method of shopping online with real-time data sharing between multiple clients by executing computer-executable instructions stored on a non-transitory computer-readable medium, the method as claimed in claim 1 comprises,
updating said each of said plurality of temporary accounts on said list of participants with said web server and said database server at regular intervals to maintain each of said plurality of shopping sessions.

8. The method of shopping online with real-time data sharing between multiple clients by executing computer-executable instructions stored on a non-transitory computer-readable medium, the method as claimed in claim 1 comprises,
finding said particular product on said list of products with said main menu feature, said session participant feature, or said search product feature for said first temporary account;
categorizing and systematically displaying said list of products with said main menu feature;
displaying said screen name of said second temporary account to said first temporary account with said session participant feature if said list of participants of said active shopping session includes both said first temporary account and said second temporary account;
retrieving a product search criteria for said particular product with said product search feature;
accessing said database server to search said list of products with said product search criteria;
locating said particular product from said list of products with said main menu feature, said session participant feature, or said search product feature and displaying said description data of said particular product on a said product detail screen; and
prompting with product detail screen between adding said description data of said particular product to said shopping cart of said first temporary account, adding said description data of said particular product to said wish list of said first temporary account, and adding said description data of said particular product to said share list of said active shopping session.

9. The method of shopping online with real-time data sharing between multiple clients by executing computer-executable instructions stored on a non-transitory computer-readable medium, the method as claimed in claim 8 comprises,
indicating to said first temporary account with a color scheme through said session participant feature if said second temporary account is viewing said same product detail screen as said first temporary account;
indicating to said first temporary account with said color scheme through said session participant feature if said second temporary account is not viewing said product detail screen;
indicating to said first temporary account with said color scheme through said session participant feature if said second temporary account is viewing said different product detail screen;
prompting to display said product detail screen viewed by said second temporary account for said first temporary account;
prompting to enter a shopper following mode; and
prompting to display said product detail screen originally viewed by said first temporary account.

10. The method of shopping online with real-time data sharing between multiple clients by executing computer-executable instructions stored on a non-transitory computer-readable medium, the method as claimed in claim 9 comprises,
displaying every product detail screen viewed by said second temporary account for said first temporary account; and
prompting to stop displaying every product detail screen viewed by said second temporary account for said first temporary account and to exit said shopper following mode.

11. The method of shopping online with real-time data sharing between multiple clients by executing computer-executable instructions stored on a non-transitory computer-readable medium, the method as claimed in claim 8 comprises,
prompting to display said share list with said main menu feature;
displaying said share list of said active shopping session to said first temporary account; and
prompting to add said particular product on said share list to said wish list of said first temporary account or said shopping cart of said first temporary account.

12. The method of shopping online with real-time data sharing between multiple clients by executing computer-executable instructions stored on a non-transitory computer-readable medium, the method as claimed in claim 8 comprises,
prompting to display said wish list with said main menu feature;
displaying said wish list of said first temporary account to said first temporary account; and
prompting to add said particular product on said wish list to said share list of said active shopping session or said shopping cart of said first temporary account.

13. The method of shopping online with real-time data sharing between multiple clients by executing computer-executable instructions stored on a non-transitory computer-readable medium, the method as claimed in claim 8 comprises,
prompting to display said shopping cart with said main menu feature; and
displaying said shopping cart of said first temporary account to said first temporary account.

14. The method of shopping online with real-time data sharing between multiple clients by executing computer-executable instructions stored on a non-transitory computer-readable medium, the method as claimed in claim 1 comprises,
prompting said first temporary account to compile a list of transfer items from said shopping cart of said first temporary account;
prompting said second temporary account to accept transferring of said list of transfer items from said shopping cart of said first temporary account to said shopping cart of said second temporary account; and
transferring said description data of each said particular product on said list of transfer items to said shopping cart of said second temporary account.

15. The method of shopping online with real-time data sharing between multiple clients by executing computer-executable instructions stored on a non-transitory computer-readable medium, the method as claimed in claim 14 comprises,
prompting said first temporary account to transfer said list of transfer items from said shopping cart of said second temporary account back to said shopping cart of said first temporary account; and
transferring said description data of said particular product on said list of transfer items to said shopping cart of said first temporary account.
